(19) United States
(12) Patent Application Publication
(10) Pub. No.: US 2021/0326003 A1
(43) Pub. Date: Oct. 21, 2021

(54) STRETCHABLE TOUCH PANEL

(71) Applicant: SHENZHEN ROYOLE TECHNOLOGIES CO., LTD., Shenzhen (CN)

(72) Inventor: He LI, Shenzhen (CN)

(21) Appl. No.: 17/360,311

(22) Filed: Jun. 28, 2021

Related U.S. Application Data
(63) Continuation-in-part of application No. PCT/CN2018/124927, filed on Dec. 28, 2018.

(51) Int. Cl. G06F 3/044

(52) U.S. Cl. CPC G06F 3/0445; G06F 2203/04102; G06F 3/0448

(57) ABSTRACT

The present disclosure discloses a stretchable touch panel, including a substrate (100) and a touch wire (200). Multiple regions having different stretch ratios are formed on the substrate (100). The touch wire (200) includes first connecting lines (210) and second connecting lines (220) connected to the first connecting lines (210). The first connecting lines (210) are disposed in regions having a lower stretch ratio. The second connecting lines (220) are disposed in regions having a higher stretch ratio. According to the present disclosure, the first connecting lines (210) and the second connecting lines (220) are correspondingly disposed in regions having different stretch ratios, such that the stretchable touch panel can have a stretch function without substantial impact on the touch wire during stretching, thereby guaranteeing functional stability of the stretchable touch panel.

### CROSS-REFERENCE TO RELATED APPLICATION

This application is a continuation-in-part of International Disclosure No. PCT/CN2018/124927, filed on Dec. 28, 2018. The entirety of the above-mentioned patent application is hereby incorporated by reference herein and made a part of this specification.

### TECHNICAL FIELD

The present disclosure relates to the field of touch sensing technologies, and in particular, to a stretchable touch panel.

### BACKGROUND

Stretchable touch panels are more and more favored by some enterprises, universities and research institutions, which gradually take the stretchable touch panels as a focus of research and development. However, there are no mature stretchable touch panel products in the market.

An existing stretchable touch panel can perform a touch function in a stretched state to some extent; however, due to its simple structure which uses stretchable design in the whole panel, all conductive lines in the plane need to be stretched. Therefore, all the conductive lines are required to have a stretching resistance capability. In addition, this type of stretchable touch panel has a high probability of failure after being stretched for a certain number of times, and its functional stability is poor.

### SUMMARY

To overcome the defects in the related art, the present disclosure provides a stretchable touch panel to solve the problem of poor functional stability of an existing stretchable touch panel.

For this purpose, according to the embodiments of the present disclosure, the stretchable touch panel includes:

a substrate comprising multiple regions comprising first regions and second regions having stretch ratio larger than that of the first regions; and

a touch wire comprising first connecting lines and second connecting lines connected to the first connecting lines, wherein the first connecting lines are respectively located at the first regions, and the second connecting lines are respectively located at the second regions.

As a further optional solution of the stretchable touch panel, the first connecting lines each are straight.

As a further optional solution of the stretchable touch panel, the second connecting lines each are curved or folded.

As a further optional solution of the stretchable touch panel, the curved line type includes a sine type, a horseshoe type and a wave type.

As a further optional solution of the stretchable touch panel, the second connecting lines are made of a stretch-proof conductive material.

As a further optional solution of the stretchable touch panel, the second connecting lines are formed in the second region by screen printing, transferring, spraying or sputtering.

As a further optional solution of the stretchable touch panel, the first regions and the second regions are arranged alternately in at least one direction.

As a further optional solution of the stretchable touch panel, the first regions and the second regions are arranged at intervals in the length direction of the substrate.

As a further optional solution of the stretchable touch panel, the first regions and the second regions each are strip-shaped in the width direction of the substrate. The second connecting lines each are connected between the first connecting lines disposed in the two adjacent first regions, and the second connecting lines each are located at an end of the second region in the width direction.

As a further optional solution of the stretchable touch panel, the stretchable touch panel further includes a touch functional layer disposed on one side of the first region. The touch functional layer is patterned to form multiple touch electrodes. The multiple touch electrodes are electrically connected to the first connecting lines.

As a further optional solution of the stretchable touch panel, the touch functional layer is in a sliding strip shape.

As a further optional solution of the stretchable touch panel, the first regions and the second regions are arranged at intervals in the length direction and the width direction.

As a further optional solution of the stretchable touch panel, the first regions and the second regions extend in the length direction or the width direction to form a rectangular structure. The second connecting lines each are connected between the first connecting lines disposed in the adjacent first regions.

As a further optional solution of the stretchable touch panel, the stretchable touch panel further includes touch functional layers disposed on two sides of the first region. The touch functional layer is patterned to form multiple touch sensing electrodes and multiple touch driving electrodes on the two sides of the first region respectively. The multiple touch sensing electrodes and the multiple touch driving electrodes are disposed on the two sides of the first region to form touch electrodes correspondingly. The touch electrodes are electrically connected to the first connecting lines.

As a further optional solution of the stretchable touch panel, the stretchable touch panel further includes multiple pins arranged at intervals and disposed in the second regions. The multiple pins are in one-to-one correspondences with the touch electrodes through the touch wire. The stretchable touch panel is bonded to an external functional element through the pins.

As a further optional solution of the stretchable touch panel, the stretchable touch panel further includes a protective layer overlying the substrate and configured to protect the touch wire.

As a further optional solution of the stretchable touch panel, the protective layer is made of an elastic material.

As a further optional solution of the stretchable touch panel, the substrate includes at least one elastic material and at least one inelastic material. Or, the substrate includes at least one elastic material and at least one another elastic material.

As a further optional solution of the stretchable touch panel, the substrate includes two elastic materials. One elastic material is polydimethylsiloxane. The other elastic material is liquid silicone rubber.

As a further optional solution of the stretchable touch panel, the substrate includes in parts by weight:

1 part of polydimethylsiloxane; and

0.1-1.5 parts of liquid silicone rubber.

The present disclosure has the following beneficial effects:

According to the stretchable touch panel in the above embodiments, because multiple regions having different stretch ratios are formed on the substrate, when the touch wire is laid out, the first connecting lines may be disposed in regions having a lower stretch ratio to generate smaller stretch deformations or even no stretch deformation, and the second connecting lines may be disposed in regions having a higher stretch ratio to generate stretch deformations accordingly, such that the stretchable touch panel can have a stretch function without substantial impact on the touch wire during stretching, thereby guaranteeing functional stability of the stretchable touch panel.

### BRIEF DESCRIPTION OF DRAWINGS

To describe the technical solutions in the embodiments of the present disclosure more clearly, the following briefly describes the accompanying drawings required for describing the embodiments. It should be understood that the following accompanying drawings merely show some embodiments of the present disclosure and thus should not be construed as limiting the scope, and a person of ordinary skill in the art may still derive others relevant drawings from these accompanying drawings without creative efforts.

FIG. 1 shows a comparison diagram illustrating stretch fracture tests on three substrates A, B and C;

FIG. 2 shows a front view illustrating a stretchable touch panel provided by Embodiment 1 according to the present disclosure;

FIG. 3 shows a side view illustrating the stretchable touch panel provided by Embodiment 1 according to the present disclosure;

FIG. 4 shows a schematic diagram illustrating the stretched stretchable touch panel provided by Embodiment 1 according to the present disclosure;

FIG. 5 shows a front view illustrating a stretchable touch panel provided by Embodiment 2 according to the present disclosure;

FIG. 6 shows a side view illustrating the stretchable touch panel provided by Embodiment 2 according to the present disclosure;

FIG. 7 shows a schematic structural diagram illustrating one side of the stretchable touch panel provided by Embodiment 2 according to the present disclosure; and

FIG. 8 shows a schematic structural diagram illustrating the other side of the stretchable touch panel provided by Embodiment 2 according to the present disclosure.

### DESCRIPTIONS OF REFERENCE NUMERALS OF MAIN ELEMENTS

100—substrate; 200—touch wire; 300—touch sensing pattern; 400—pin; 500—protective layer; 110—first region; 120—second region; 210—first connecting line; and 220—second connecting line.

### DESCRIPTION OF EMBODIMENTS

The following describes the embodiments of the present disclosure in detail. Examples of the embodiments are illustrated in the accompanying drawings. Identical or similar reference numerals represent identical or similar elements or elements that have identical or similar functions from beginning to end. The embodiments described below with reference to the accompanying drawings are exemplary and are merely intended to interpret the present disclosure and should not be understood as limiting the present disclosure.

In the description of the present disclosure, it should be understood that the orientation or positional relationships indicated by the terms “center”, “longitudinal”, “lateral”, “length”, “width”, “thickness”, “up”, “down”, “front”, “rear”, “left”, “right”, “vertical”, “horizontal”, “top”, “bottom”, “inner”, “outer”, “clockwise”, “anticlockwise”, “axial”, “radial”, “circumferential”, etc. are based on the orientation or positional relationships shown in the accompanying drawings and are merely for ease in describing the present disclosure and simplifying this description, but not to indicate or imply that an indicated device or element must have a particular orientation and be constructed and operated in a particular orientation, and thus they should not be construed as limitations on the present disclosure.

Further, the terms “first” and “second” are merely used for description and cannot be construed as indicating or implying relative importance or implicitly indicating the number of the technical features indicated. Therefore, the features defined by “first” and “second” can expressly or implicitly include one or more such features. In the description of the present disclosure, “multiple” means two or more, unless otherwise expressly specified.

In the present disclosure, unless otherwise expressly stipulated and specified, the terms “mounted”, “connected to”, “connected”, “fixed”, etc. should be understood broadly, e.g., “fixed” may be fixedly connected, or may be detachably connected or integrated; may be mechanically connected, or may be electrically connected; may be directly connected, may be indirectly connected by a medium, or may be internal communication between two elements or an interactive relationship between two elements. A person of ordinary skill in the art may understand specific meanings of the preceding terms in the present disclosure based on a specific situation.

In the present disclosure, unless otherwise expressly stipulated and specified, a first feature is “above” or “below” a second feature may indicate that the first feature and the second feature are in direct contact, or the first feature and the second feature are in indirect contact by a link. Moreover, the first feature is “above”, “overlying” and “on” the second feature may indicate that the first feature is over or above the second feature, or merely indicate that a horizontal height of the first feature is larger than that of the second feature. The first feature is “below”, “under” and “beneath” the second feature may indicate that the first feature is under or below the second feature, or merely indicate that a horizontal height of the first feature is smaller than that of the second feature.

An embodiment of the present disclosure provides a stretchable touch panel. The stretchable touch panel can feature stretchability on the basis of implementing functions of a touch panel, thereby implementing a touch function in a stretched state.

The stretchable touch panel includes a substrate 100 and a touch wire 200 for implementing a touch function.

Multiple regions having different stretch ratios are formed on the substrate 100. The touch wire 200 includes first connecting lines 210 and second connecting lines 220 connected to the first connecting lines 210. The first connecting lines 210 are disposed in regions having a lower stretch ratio. The second connecting lines 220 are disposed in regions having a higher stretch ratio.

It should be noted herein that “first connecting line 210” refers to a part of the touch wire having a decisive effect on the touch function of the touch wire 200.

“Second connecting line 220” refers to an auxiliary part of the touch wire connected between “first connecting lines 210”, and in most cases, has an auxiliary effect on the touch function of the touch wire 200.

In addition, it should be noted that a value of a stretch ratio represents a degree of a stretch deformation, i.e., under the action of same tensile force, a region having a higher stretch ratio generates a larger stretch deformation, and a region having a lower stretch ratio generates a smaller stretch deformation.

A touch functional layer may be formed on the region having the lower stretch ratio to connect the first connecting line. In the present disclosure, the first connecting lines 210 and the second connecting lines 220 in conjunction with an external functional element (e.g., a PCB), and the touch functional layer, can perform the touch function. At this point, because the touch functional layer is disposed in the region having the lower stretch ratio, the touch functional layer can be prevented from generating a stretch deformation or a relatively large stretch deformation, thereby avoiding a stretch deformation from reducing sensing precision of touch signals.

In addition, because the touch functional layer is not prone to stretch after being disposed in the region having the lower stretch ratio, the touch functional layer may have a complex touch sensing pattern 300 to implement a more complex touch function, as described in Embodiment 2 below.

Therefore, because multiple regions having different stretch ratios are formed on the substrate 100, when the touch wire 200 is laid out, the first connecting lines 210 may be disposed in the regions having the lower stretch ratio to generate a relatively small stretch deformation or even no stretch deformation, and the second connecting lines 220 may be disposed in the regions having the higher stretch ratio to generate a stretch deformation accordingly, such that the stretchable touch panel can have a stretch function without substantial impact on the touch wire 200 during stretching, thereby implementing a more complex touch function and meanwhile guaranteeing functional stability of the stretchable touch panel.

In addition, because the first connecting lines 210 are disposed in the regions having the lower stretch ratio to generate no stretch deformation or only a relatively small stretch deformation along with the regions having the lower stretch ratio, the first connecting line 210 may be provided with a simple line type structure, e.g., a straight line type, when serving as a peripheral wire of the stretchable touch panel, thereby greatly saving a peripheral wire space of the stretchable touch panel and releasing more functional regions. Here, reference may be made to Embodiment 1 below.

In general, the second connecting lines 220 each is a line connected between adjacent first connecting lines 210. The second connecting lines 220 are connected to the first connecting lines 210.

As previously described, because the second connecting lines 220 are disposed in the regions having the higher stretch ratio to generate a stretch deformation along with the regions having the higher stretch ratio, the second connecting lines 220 are better to be constructed as a curved line type or a polyline type so as to realize stretch-proof performance.

The curved line type may include a sine type, a horseshoe type, a wave type and various other types, which are not described exhaustively in the present disclosure. However, a person skilled in the art and a relevant person should select a specific curved line type based on actual circumstances without any obstacle, e.g., the curved line type adopted by the second connecting lines 220 in Embodiment 1 and Embodiment 2 below is the sine type.

Certainly, in certain embodiments, the second connecting lines 220 may further possess relatively good stretch-proof performance by changing their compositional materials. For example, some stretch-proof conductive materials may be selected to prepare the second connecting lines 220, e.g., a stretch-proof aluminum alloy material or a stretch-proof nickel-aluminum alloy material.

As previously described, because the first connecting lines 210 and the second connecting lines 220 are disposed in different regions and have different performance, selections of a line type and a material or a combination thereof of the first connecting lines 210 and the second connecting lines 220 may be various.

For example, in certain embodiments, a non-stretch-proof conductive material (of course can also select a stretch-proof conductive material) may be selected for the first connecting lines 210, and a line type thereof may be set to the straight line type. A stretch-proof conductive material may be selected for the second connecting lines 220. Then, the two lines are connected into a whole. In this case, the second connecting lines 220 may use the straight line type or the curved line type.

In another example, in some other embodiments, a non-stretch-proof conductive material (which certainly may alternatively be a stretch-proof conductive material) may be selected for the first connecting lines 210, and a line type thereof may be set to the straight line type. A non-stretch-proof conductive material may be selected for the second connecting lines 220. Then, the two lines are connected into a whole. In this case, the second connecting lines 220 may be the curved line type.

In an embodiment in which the first connecting lines 210 and the second connecting lines 220 use the same material, the first connecting lines 210 and the second connecting lines 220 may be the same connecting line. In this case, the two lines have no difference and are an integrated connecting line. For example, in Embodiment 1 and Embodiment 2 to be described below, the second connecting lines 220 and the first connecting lines 210 are connecting lines of the same material, but they have different line type structures. The first connecting lines 210 are the straight line type. The second connecting line 220 are the curved line type. To further obtain relatively high stretchability, the first connecting lines 210 and the second connecting lines 220 may both be made of a stretch-proof conductive material.

In another aspect, because the first connecting lines 210 are disposed in the regions having the lower stretch ratio to generate no stretch deformation or a very small stretch deformation, in this case, the first connecting lines 210 may be directly attached to the regions having the lower stretch ratio during a manufacturing process. The second connecting lines 220 are disposed in the regions having the higher stretch ratio which may be stretched, such that the second connecting lines 220 are formed in the regions having the higher stretch ratio during the manufacturing process by screen printing, transferring, spraying or sputtering.

Based on numerous research and repeated experiments, the inventor of the present disclosure learn that, when one or more elastic materials and another one or more inelastic materials are blended at different ratios to form the substrate 100, or one or more elastic materials and another one or more elastic materials are blended at different ratios to form the substrate 100, the substrate 100 shows the following mechanical and physical properties: tensile strength is substantially consistent, but stretch ratios may be significantly different. In other words, tension required to break the substrate 100 is consistent, but stretch deformation may be significantly different.

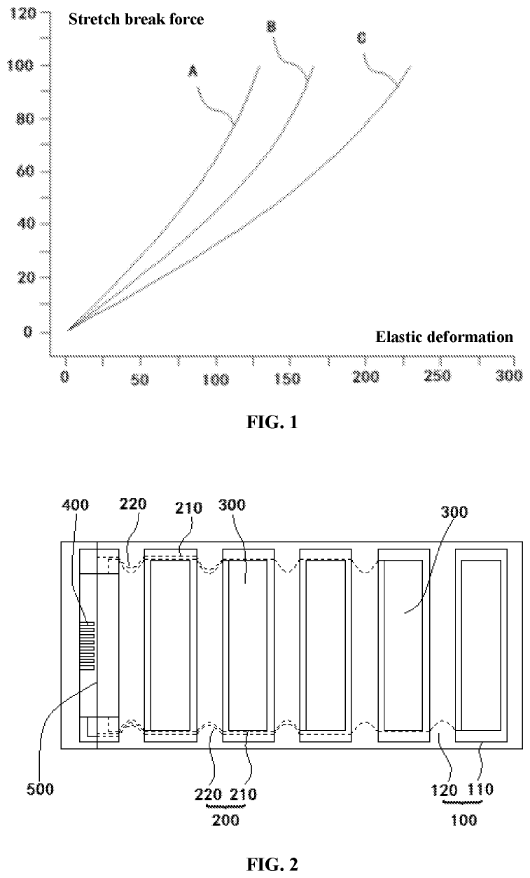

Taking two elastic materials (polydimethylsiloxane and liquid silicone rubber) as an example, when the two elastic materials are blended in parts by weight as below, performance thereof is shown in FIG. 1.

For ease of understanding, three blend ratios are selected as below:

A: polydimethylsiloxane:liquid silicone rubber=1:(0.1-0.5);

B: polydimethylsiloxane:liquid silicone rubber=1:(0.5-1); and

C: polydimethylsiloxane:liquid silicone rubber=1:(1-1.5).

When stretch break tests are performed on the substrates 100 formed at the above three blend ratios, stretch break force is substantially 100 kPa, but stretch deformations are significantly different. The stretch deformation at ratio A is the minimum, the stretch deformation at ratio C is the maximum, and the stretch deformation at ratio B is intermediate.

The preceding substrate 100 is completed on the basis of the above theory. In this case, the substrate 100 may include at least one elastic material and at least one inelastic material. Or, the substrate 100 may include at least one elastic material and at least one another elastic material. For example, with reference to the above blend ratios of polydimethylsiloxane to liquid silicone rubber, A is set for the regions having the lower stretch ratio, and C is set for the regions having the higher stretch ratio.

In particular, when formed by blending polydimethylsiloxane and liquid silicone rubber, the substrate 100 may be implemented by using a corresponding mold. The regions having different stretch ratios may be obtained by injecting polydimethylsiloxane and liquid silicone rubber at a corresponding ratio into corresponding regions in a mold and then curing the polydimethylsiloxane and liquid silicone rubber.

For ease of the following description, the regions having the lower stretch ratio described above are called first regions 110, and the regions having the higher stretch ratio described above are called second regions 120. In other words, the substrate 100 includes the first regions 110 and the second regions 120. A stretch ratio of the first regions 110 is smaller than a stretch ratio of the second regions 120.

To make the substrate 100 being stretchable in multiple directions, the first regions 110 and the second regions 120 are arranged at intervals in at least one direction. The first connecting lines 210 are disposed in the first regions 110. The second connecting lines 220 are disposed in the second regions 120.

The following further describes the present disclosure in detail by using specific embodiments with reference to the accompanying drawings.

### Embodiment 1

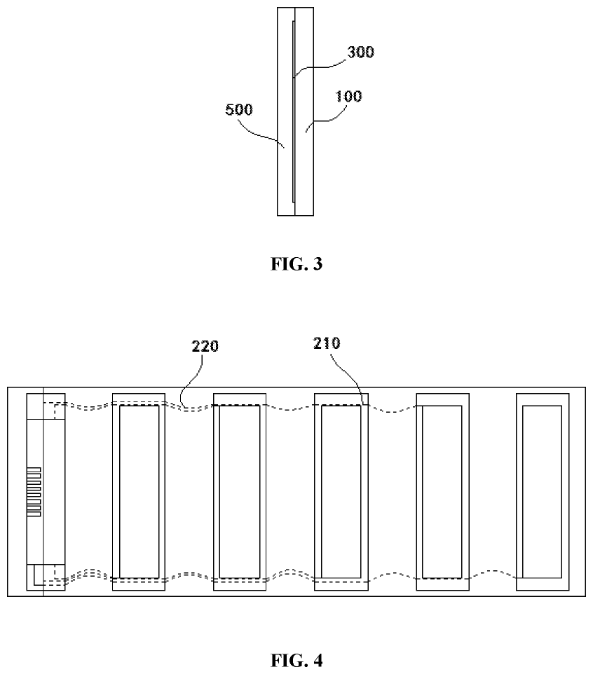

With reference to FIG. 2 to FIG. 4, first regions 110 and second regions 120 of a substrate 100 in a stretchable touch panel provided by Embodiment 1 are arranged at intervals in the length direction to form a self-capacitive stretchable touch panel.

In this case, it can be understood that after first connecting lines 210 are disposed in the first regions 110 and second connecting lines 220 are disposed in the second regions 120, the stretchable touch panel can be formed, and the stretchable touch panel is stretchable in the length direction.

In particular, with reference to FIG. 2 and FIG. 4, the second connecting lines 220 use a sine line type. During stretching, the second connecting lines 220 may be stretched along with the second regions 120. Afterwards, stretching of the whole stretchable touch panel is realized.

The first connecting lines 210 may generate no stretch deformation or only small stretch deformations along with the first regions 110. In this case, the first connecting lines 210 can be well protected. The first connecting lines 210 are mainly configured to transmit touch signal of the stretchable touch panel. Therefore, impact of a stretch deformation on touch signals can be avoided or reduced, and touch precision is improved.

In this embodiment, the first regions 110 and the second regions 120 both extend in the width direction to form a strip-shaped structure. The second connecting lines 220 each are connected between the first connecting lines 210 disposed in adjacent first regions 110, and are located at an end of the second region 120 in the width direction.

In this case, corresponding to the preceding description, the second connecting lines 220 each are disposed at an end of the second region 120, such that the second connecting lines 220 can form a part of a peripheral wire of a touch wire 200. At this point, at least the first connecting lines 210 connected to the second connecting lines 220 can be constructed in the straight line type, thereby saving a peripheral wire space of the stretchable touch panel and releasing more functional regions.

Following the preceding description, in this embodiment, a touch functional layer is disposed on one side of the first region 110. The touch functional layer is patterned to form multiple touch electrodes (touch sensing pattern 300). The multiple touch electrodes are electrically connected to the first connecting lines 210.

In addition, in this embodiment, the touch functional layer may be in a strip shape. Certainly, in other embodiments, the touch functional layer may alternatively be set in a triangle shape or other shapes, etc.

Following the preceding description, multiple pins 400 arranged at intervals are further disposed in the first region 110. The multiple pins 400 are in one-to-one correspondences with the touch electrodes through the touch wire 200. The stretchable touch panel is bonded to an external functional element (e.g., a PCB) through the pins 400.

At this point, a touch function of the stretchable touch panel can be implemented by the touch functional layer.

### Embodiment 2

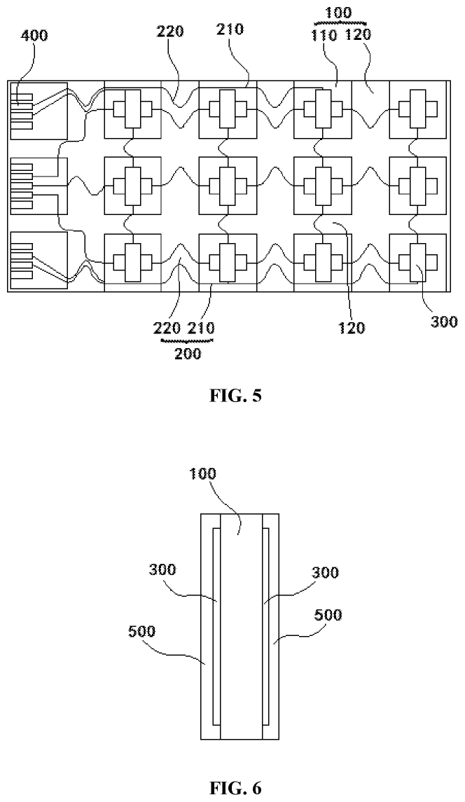

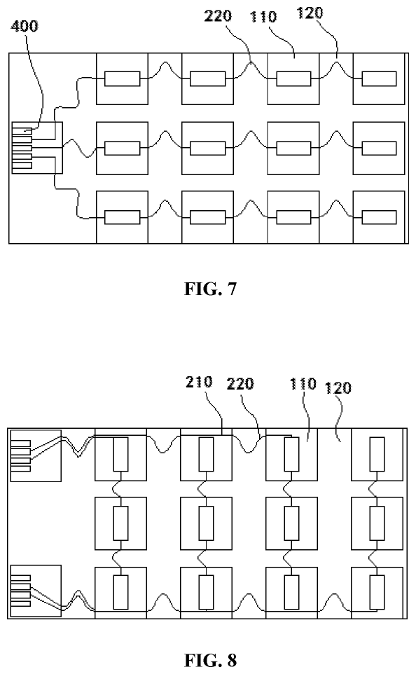

With reference to FIG. 5 to FIG. 8, different from Embodiment 1 described above, first regions 110 and second regions 120 of a substrate 100 in a stretchable touch panel provided by Embodiment 2 are arranged at intervals in the length direction and the width direction to form a mutual-capacitive stretchable touch panel, thereby implementing a complex touch function such as multi-touch.

In this embodiment, the substrate 100, the first connecting lines 210 and the second connecting lines 220 are arranged in a single direction, as in the case with Embodiment 1 described above, such that the stretchable touch panel is stretchable in both the length direction and the width direction.

In this embodiment, the first regions 110 and the second regions 120 extend in the length direction or the width direction to form a rectangular structure. The second connecting lines 220 each are connected between the first connecting lines 210 disposed in adjacent first regions 110.

In this embodiment, the first connecting lines 210 and the second connecting lines 220 are disposed on two opposite sides of the substrate 100. The first connecting lines 210 and the second connecting lines 220 disposed on one side of the substrate 100 correspondingly intersect with the first connecting lines 210 and the second connecting lines 220 disposed on the other side of the substrate 100.

Therefore, because the first connecting lines 210 and the second connecting lines 220 disposed in the length direction and the width direction are in an intersected state, the first connecting lines 210 and the second connecting lines 220 disposed in the length direction or the width direction constitute receiving lines (RX lines) of the stretchable touch panel, the first connecting lines 210 and the second connecting lines 220 disposed in the width direction or the length direction constitute transmitting lines (TX lines) of the stretchable touch panel. The above two types of lines intersect in the first regions 110 and may be stretched in both directions. Therefore, they are not prone to shifts caused by stretch deformations, and stability of touch performance is also improved. On this basis, a complex touch function can be implemented.

Similar to Embodiment 1 described above, in this embodiment, a touch functional layer is also disposed. But different from Embodiment 1, in this embodiment, the touch functional layer is patterned to form multiple touch sensing electrodes and multiple touch driving electrodes on two opposite sides of the first region 110 respectively. The multiple touch sensing electrodes and the multiple touch driving electrodes are disposed on the two opposite sides of the first region 110 to form touch electrodes correspondingly. The touch electrodes are electrically connected to the first connecting lines 210.

In this case, the stretchable touch panel may be stretched in both the length direction and the width direction, the touch functional layer generates no stretch deformation or only a relatively small stretch deformation during stretching, a touch sensing pattern 300 formed by the touch functional layer may become complex, thereby implementing a more complex touch function such as multi-touch.

Similar to Embodiment 1 described above, in this embodiment, multiple pins 400 arranged at intervals are further disposed in the first regions 110. The multiple pins 400 are in one-to-one correspondences with the touch electrodes through touch wires 200. The stretchable touch panel is bonded to an external functional element (e.g., a PCB) through the pins 400.

At this point, a touch function of the stretchable touch panel can be implemented by the touch functional layer.

It should be understood that, although a single-substrate and double-sided line design solution is adopted in this embodiment, i.e., one substrate 100 serves as a base and the first connecting lines 210 and the second connecting lines 220 are disposed on the two opposite sides of the substrate 100, a double-substrate and double-layer line design solution may alternatively be available, i.e., the first connecting lines 210 and the second connecting lines 220 arranged in the length direction are disposed on one substrate 100, the first connecting lines 210 and the second connecting lines 220 arranged in the width direction are disposed on the other substrate 100. By combining the two substrates 100, a more complex touch function can be implemented.

Finally, it should be noted that first regions 110 and second regions 120 arranged at intervals may further be added in the thickness direction on the basis of Embodiment 2, such that the stretchable touch panel further is stretchable in the thickness direction.

In addition, it should be noted that in Embodiment 1 and Embodiment 2 described above, a protective layer 500 may further overlie the substrate 100 and be configured to protect the touch wire 200, i.e., the first connecting lines 210 and the second connecting lines 220.

The protective cover 500 may be made of an elastic material, e.g., a material similar to that of the substrate 100, such that the protective layer 500 can generate a stretch deformation along with the substrate 100.

Certainly, in other embodiments, the elastic material may be randomly selected as required, e.g., may be rubber, silicone rubber, etc.

In the description of this specification, reference to the description of the terms “one embodiment”, “some embodiments”, “example”, “specific example”, “some examples”, etc. means that particular features, structures, materials, or characteristics described in connection with the embodiments or examples are included in at least one embodiment or example of the present disclosure. In this specification, schematic representations of the above terms do not necessarily refer to the same embodiment or example. Furthermore, the particular features, structures, materials, or characteristics described may be combined in a suitable manner in any one or more embodiments or examples. In addition, a person skilled in the art may combine different embodiments or examples and features of different embodiments or examples described in this specification provided that no conflict occurs.

Although the embodiments of the present disclosure have been illustrated and described above, it can be understood that the above embodiments are exemplary and cannot be construed as limitations on the present disclosure. A person of ordinary skill in the art can make changes, modifications, replacements and variations on the above embodiments within the scope of the present disclosure.

What is claimed is:

1. A stretchable touch panel, comprising:
a substrate comprising multiple regions comprising first regions and second regions having stretch ratio larger than that of the first regions; and
a touch wire comprising first connecting lines and second connecting lines connected to the first connecting lines, wherein the first connecting lines are respectively located at the first regions, and the second connecting lines are respectively located at the second regions.

2. The stretchable touch panel according to claim 1, wherein the first connecting lines each are straight.

3. The stretchable touch panel according to claim 1, wherein the second connecting lines each are curved or folded.

4. The stretchable touch panel according to claim 1, wherein the second connecting lines each are sine-shaped, a horseshoe-shaped or wave-shaped.

5. The stretchable touch panel according to claim 1, wherein the second connecting lines each are made of a stretch-proof conductive material.

6. The stretchable touch panel according to claim 1, wherein the second connecting lines are formed in the second regions by screen printing, transferring, spraying or sputtering.

7. The stretchable touch panel according to claim 1, wherein the first regions and the second regions are arranged alternately in at least one direction.

8. The stretchable touch panel according to claim 1, wherein the first regions and the second regions are arranged alternately in a length direction of the substrate.

9. The stretchable touch panel according to claim 8, wherein the first regions and the second regions each are strip-shaped in a width direction of the substrate, and the second connecting lines each are connected between the first connecting lines located at two adjacent first regions, and the second connecting lines each are located at an end of a corresponding second region in the width direction of the substrate.

10. The stretchable touch panel according to claim 9, further comprising a touch functional layer disposed on one side of the first regions, wherein the touch functional layer is patterned to form multiple touch electrodes, and the multiple touch electrodes are electrically connected to the first connecting lines, respectively.

11. The stretchable touch panel according to claim 10, wherein each touch electrode is a strip.

12. The stretchable touch panel according to claim 7, wherein the first regions and the second regions are arranged alternately in both the length direction and the width direction of the substrate.

13. The stretchable touch panel according to claim 12, wherein each first region is surrounded by a plurality of the second regions to form an island.

14. The stretchable touch panel according to claim 1, further comprising touch functional layers respectively disposed on two opposite sides of the substrate, wherein the touch functional layers are patterned to form multiple touch sensing electrodes and multiple touch driving electrodes on the two opposite sides of the substrate respectively, each touch sensing electrode and a corresponding touch driving electrode are disposed on two opposite sides of a corresponding first region to form touch electrodes correspondingly, and the touch electrodes are electrically connected to the first connecting lines.

15. The stretchable touch panel according to claim 14, further comprising multiple pins arranged at intervals in the first regions, respectively, wherein the multiple pins are in one-to-one correspondences with the touch electrodes through the touch wire, and the stretchable touch panel is bonded to an external functional element through the pins.

16. The stretchable touch panel according to claim 1, further comprising a protective layer overlying the substrate to protect the touch wire.

17. The stretchable touch panel according to claim 16, wherein the protective layer is made of an elastic material.

18. The stretchable touch panel according to any one of claim 1, wherein the substrate comprises at least one elastic material and at least one inelastic material, or the substrate comprises two elastic materials.

19. The stretchable touch panel according to claim 17, wherein the two elastic materials comprises polydimethylsiloxane and liquid silicone rubber.

20. The stretchable touch panel according to claim 19, wherein the two elastic materials comprise in parts by weight:
1 part of polydimethylsiloxane; and
0.1-1.5 parts of liquid silicone rubber.
